(19) United States
(12) Patent Application Publication
(10) Pub. No.: US 2025/0103453 A1
(43) Pub. Date: Mar. 27, 2025

(54) A METHOD, SYSTEM AND COMPUTER PROGRAM PRODUCT FOR COLLECTING DATA OF THEIR SURROUNDINGS FROM A PLURALITY OF MOTOR VEHICLES BY A DATA COLLECTION SYSTEM, AS WELL AS A CORRESPONDING DATA COLLECTION SYSTEM

(71) Applicant: MERCEDES-BENZ GROUP AG, Stuttgart (DE)

(72) Inventors: Tim FENLON, Santa Clara, CA (US); Wenbing ZHANG, San Jose, CA (US); Martin MICHALAK, Sunnyvale, CA (US); Priya POPTANI, Fremont, CA (US)

(21) Appl. No.: 18/832,721

(22) PCT Filed: Jan. 17, 2023
(86) PCT No.: PCT/EP2023/051006

§ 371 Date: Jul. 24, 2024

(30) Foreign Application Priority Data
Jan. 25, 2022 (GB) 2200895.7

(51) Int. Cl. G06F 11/30; G06F 16/25

(52) U.S. Cl. CPC G06F 11/3013; G06F 16/25

(57) ABSTRACT

A method for collecting data of a surrounding of a plurality of motor vehicles by a data collection system involves generating a collection job having a first set of information describing which data are to be collected by the plurality of motor vehicles, and a second set of information describing when the data are to be collected, for the plurality of motor vehicles. The collection job is transmitted to the plurality of motor vehicles by a communication device of the data collection system. Preprocessed data is received from each motor vehicle. The surroundings of each motor vehicle were captured by a capturing device of each motor vehicle depending on the transmitted collection job to generate collected data and the collected data were preprocessed by an electronic computing device of each motor vehicle to generate preprocessed data and further processing of the transmitted and preprocessed data by the backend server.

### FIELD OF THE INVENTION

Exemplary embodiments of the invention relate to the field of automobiles, and more specifically to a method for collecting data of their surroundings from a plurality of motor vehicles by a data collection system, as well as to a corresponding data collection system.

### BACKGROUND INFORMATION

Currently, most data collection, processing, and machine learning analysis systems on vehicles collect and operate on feature data in a fixed way. However, there is a need in the art to provide a method for selecting certain data to be collected, processed, and machine learning analysis applied to a group of vehicles, starting at a certain time of the day and lasting for a given duration.

### SUMMARY OF THE INVENTION

Exemplary embodiments of the invention are directed to a method as well as a corresponding data collection system, by which a more effective way of collecting data from a plurality of motor vehicles is presented.

One aspect of the disclosure relates to a method for collecting data of their surroundings from a plurality of motor vehicles by a data collection system. A collection job comprising a first information, which data is to be collected, and a second information, when this data is to be collected, is provided for the plurality of motor vehicles by a backend server of the data collection system. Transmitting the collection job to the plurality of motor vehicles by a communication device of the collection system is performed. The surroundings of each motor vehicle are captured by a capturing device of each motor vehicle depending on the transmitted collection job. The collected data is preprocessed by an electronic computing device of each motor vehicle. The preprocessed data of each motor vehicle is transmitted to the backend server and a further processing of the transmitted and preprocessed data is performed by the backend server.

Furthermore, a method for dynamically collecting multiple vehicle data, processing collected data, conditioning data, creating feature sets, and then dynamically applying machine learning models, in particular neural networks, for various applications is presented. There is a multi-vehicle data traffic and scheduling system such that operators of the system may choose from which motor vehicles, what data is to be collected, which applications should pre-and postprocess data, and what data is analyzed on-board the motor vehicle, with specific machine learning models and software applications sent to the motor vehicle from the cloud servers, and what data may be transmitted back to a central cloud server. The unique scheduling system may select the specific types of data based on start/end time of day (TOD), geo-graphical location, and other complex triggers. The data collection system allows for what may be referred to as a “Data Collection Campaign”. A campaign may include a period where data is collected from the motor vehicles in order to train machine learning models in the cloud and then may include a campaign when trained machine learning models are distributed to the motor vehicle as part of a multi-vehicle campaign.

The vehicle sensor data is collected on the motor vehicle in many different forms, this system provides a way to collect, process, condition, and apply machine learning on this data dynamically using data processing applications, configurations, and machine learning models that are scheduled on the cloud. Machine learning models and data processing applications are dynamically distributed to groups of motor vehicles in the field based on the traffic and scheduling system. The data processing libraries and configurations are distributed to the motor vehicles and some software may be compiled just in time (JIT) on the motor vehicles or in the cloud/backend server. The machine learning models, pre-trained model data, and configurations are also distributed to the motor vehicles and inference, training is run on the motor vehicles.

In particular, the multi-vehicle data traffic and scheduling system provides cloud servers and a vehicle-based system that implements a data collection, data pre-and postprocessing, conditioning, data features and machine learning models scheduling system, using a user interface, configurations, automation systems, and big data storage systems. The data collection jobs are created on the scheduling system, and then data processing, conditioning, and machine learning models jobs are attached. These jobs are transmitted to groups of motor vehicles with the system and communicate to the motor vehicle what sensor data to collect, what data processing and conditioning to apply, and finally, which machine learning models to run on the data. The results are then transmitted from the motor vehicle back to the cloud-server big data system, where both raw data, processed data and machine learning inference results, and training data are ingested and processed on the big data cloud servers.

The method discussed above provides a way to dynamically collect data from multiple motor vehicles, process collected data, condition data, create data feature sets and then dynamically apply machine learning models for various applied machine learning applications. The system discussed above provides a mechanism to dynamically distribute machine learning models that run on-board vehicles to a group of motor vehicles using a cloud server based model store. The system provides a mechanism to dynamically distribute data processing applications that run on-board vehicles to a group of motor vehicles using a cloud server based data application store, data app store. The system provides a mechanism to dynamically select and collect vehicle sensor data that runs on-board vehicles using a cloud-based scheduling system and on-board data collection automation system.

The system allows a data engineer to dynamically create a vehicle data flow pipeline of data collection, data application processing, machine learning and results reporting in order to manage custom applied artificial intelligence applications on-board groups of vehicles. The scheduling to run this pipeline on-board the vehicles, the machine learning models and data processing applications the motor vehicles need to download are dynamically configured and distributed to groups of the motor vehicles in the system.

For each of the data collection emitters on-board, a motor vehicle can send different machine learning models from the model store, and different data processing applications may be sent from the data app store to groups of the motor vehicles within the system. The machine learning models and data preprocessing applications are connected in a pipeline that can be dynamically sent to the groups of motor vehicles and scheduling data is embedded which indicates when the data collection should start and stop.

In an embodiment, the preprocessing on each motor vehicle is performed by a machine learning algorithm of each electronic computing device.

In another embodiment the method for preprocessing on each motor vehicle is specified in the collection job.

According to another embodiment the capturing device by which the surroundings of the motor vehicles are to be captured is specified in the collection job.

According to another embodiment the data collection is triggered by a predetermined event in the surroundings of the motor vehicles, wherein the predetermined event is specified in the collection job.

In another embodiment a trigger for the data collection is a current position of a motor vehicle and/or a current speed of the motor vehicle and/or a current heading of the motor vehicle and/or a current time.

The method is, in particular, a computer-implemented method. Therefore, the invention also relates to a computer program product comprising program code means for performing the method as well as to a corresponding computer-readable storage medium.

Furthermore, the invention relates to a data collection system for collecting data of their surroundings from a plurality of motor vehicles, comprising at least one backend server and at least one communication device, wherein the data collection system is configured for performing a method according to the preceding aspect. In particular, the method is performed by the data collection system.

Further advantages, features, and details of the invention derive from the following description of preferred embodiments as well as from the drawings. The features and feature combinations previously mentioned in the description as well as the features and feature combinations mentioned in the following description of the figures and/or shown in the figures alone can be employed not only in the respectively indicated combination but also in any other combination or taken alone without leaving the scope of the invention.

### BRIEF DESCRIPTION OF THE DRAWINGS

The novel features and characteristic of the disclosure are set forth in the appended claims. The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

The drawings show in:

FIG. 1 a schematic top view according to an embodiment of a motor vehicle comprising different capturing devices for capturing the surroundings of the motor vehicle;

FIG. 2 a schematic block diagram according to an embodiment of the method;

FIG. 3 a schematic block diagram according to a step of the method according to FIG. 2;

FIG. 4 another step according to the method presented in FIG. 2;

FIG. 5 another step of the method presented in FIG. 2;

FIG. 6 another step of the method presented in FIG. 2;

FIG. 7 another step of the method presented in FIG. 2;

FIG. 8 shows a schematic block diagram of an embodiment of a data collection system; and

FIG. 9 shows a schematic flowchart according to an embodiment of the method.

In the figures the same elements or elements having the same function are indicated by the same reference signs.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiment of the disclosure, reference is made to the accompanying drawings that form part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

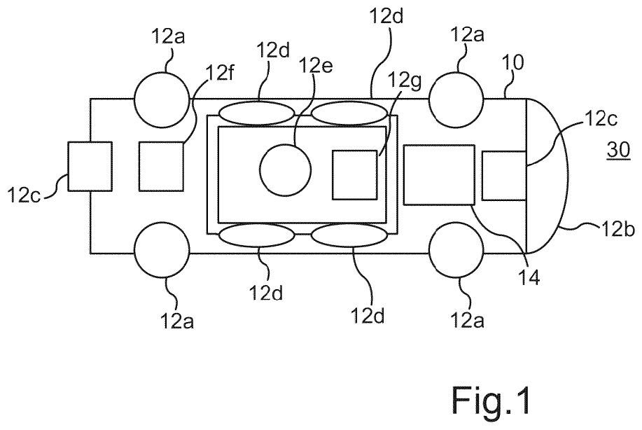

FIG. 1 shows a schematic top view according to the embodiment of a motor vehicle 10. The motor vehicle 10 comprises a plurality of capturing devices 12a to 12g. For example, the motor vehicle 10 may comprise a sensor 12a for capturing the RPM of a wheel. Furthermore, a radar 12b as well as a camera 12c may be arranged on the motor vehicle 10. A window sensor 12d as well as a LIDAR sensor 12e may be arranged on the motor vehicle 10. Furthermore, the motor vehicle 10 may comprise a GPS sensor 12f as well as a so-called dash cam 12g. The motor vehicle 10 may further comprise an electronic computing device 14.

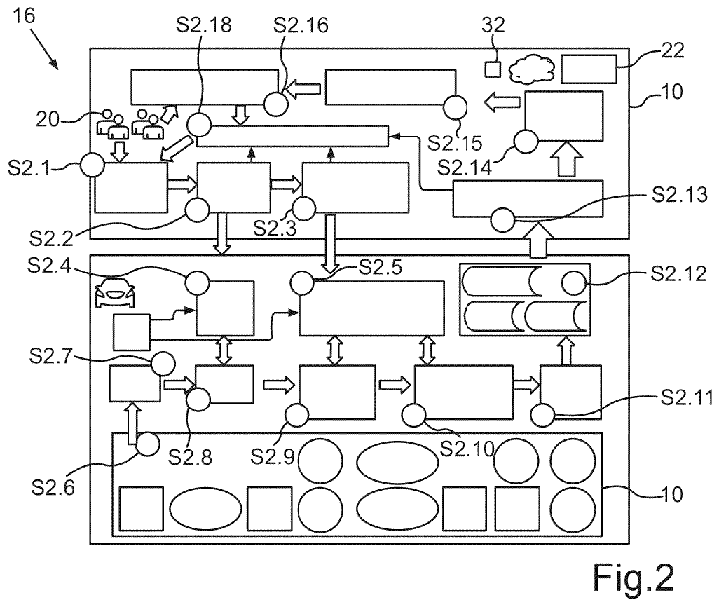

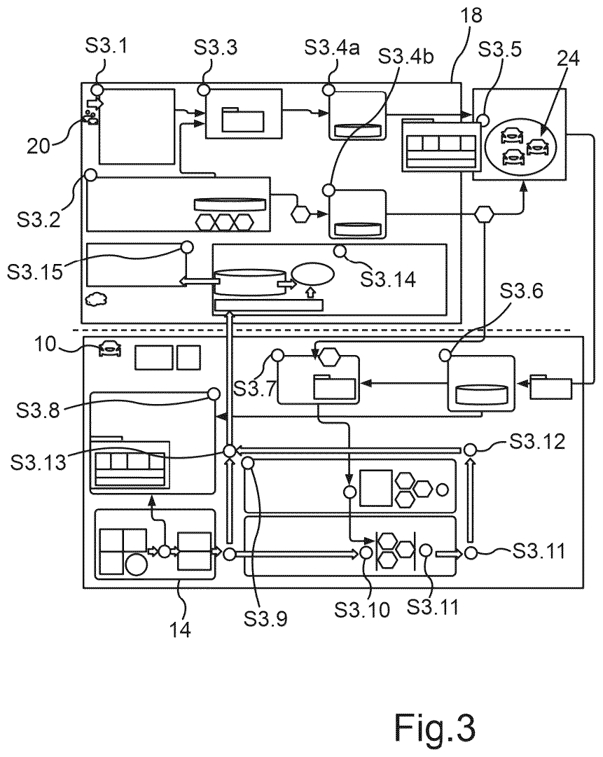

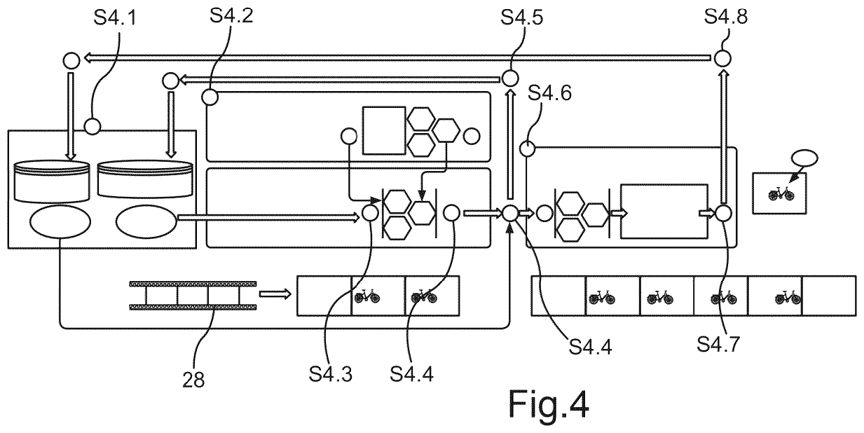

According to the embodiment a method for collecting data 28 (FIG. 4) of their surroundings 30 from a plurality of motor vehicles 24 (FIG. 3) by a collection system 16 (FIG. 2) is provided.

Therefore, the data collection system includes a backend server 18 that performs a collection job comprising generating a first set of information, which describes which data 28 or what type of data are to be collected by, e.g., a plurality of motor vehicles, and a second set of information, which describes when these data 28 are to be collected, for the plurality of motor vehicles 24. The collection job can be, for example, a task that is performed. This task can include generating a request and/or command describing data to be captured and when they are to be captured. The task can further include transmitting the request and/or command to the motor vehicles. The collection job, or more specifically the information in the collection job, is transmitted to the plurality of motor vehicles 24 by a communication device 32 (FIG. 2) of the collection system 16. The surroundings 30 are captured by the capturing device 12a to 12g of each motor vehicle 10 depending on the transmitted collection job. The collected data 28 are preprocessed by the electronic computing device 14 of each motor vehicle 10. The preprocessed data 28 are transmitted to the backend server 18 and a further processing of this transmitted and preprocessed data 28 is performed by the backend server 18.

In an embodiment the preprocessing on each motor vehicle 10 is performed by a machine learning algorithm of each electronic computing device 14, for example via a trained machine learning model. Furthermore, the method for processing on each motor vehicle 10 is specified in the collection job. The capturing device 12a to 12g by which the surroundings 30 of the motor vehicle 10 are to be captured is specified in the collection job. Furthermore, the data collection is triggered by a predetermined event in the surroundings 30 of the motor vehicle 10, wherein the predetermined event is specified in the collection job. Furthermore, a trigger for the data collection is a current position of the motor vehicle 10 and/or a current speed of the motor vehicle 10 and/or a current heading of the motor vehicle 10 and/or a current time.

The multi-vehicle data traffic and scheduling system, which is an example of the data collection system 16, provides backend cloud servers and vehicle-based system that implements a data collection, data processing, conditioning, data features and machine learning models scheduling system, using a UI (User Interface), configurations, automation systems and big data storage systems. The Data Collections jobs are created on the scheduling system, and then Data Processing, Conditioning, and Machine Learning Models jobs are attached. These “Jobs” are transmitted to the plurality of motor vehicles 24 with the system and communicate to each motor vehicle 10, what sensor data to collect, what data processing and conditioning to apply and finally, which Machine Learning Models to run on the data 28. The results are then transmitted from the motor vehicle 10 back to the cloud-server big data system, where both raw data, processed data and machine learning inference results, and training data are ingested and processed on the big data cloud servers.

There are many use cases that the scheduling system is able to cover. One of the use cases is now described by example only. A thesis “There are more blue bikes than red bikes in San Francisco” is created. In order to answer the premise of the thesis, some camera data on many vehicles in San Francisco needs to be collected, some processing on the camera data needs to be done, some machine learning needs to be run which reports if bicycles are seen in an image called “Inference” and what colors the bicycles are and, raw, processed, conditioned data plus ML results need to be reported to the multi-vehicle cloud-server.

The collection system 16 starts with the vehicle data product owners and data scheduling operators using a GUI (Graphical User Interface) or equivalent to schedule which data features are to be collected on a group of motor vehicles 24 at a certain time of day (time/date). There exists a Vehicle Data Registry with a database of all available sensor data on different vehicle types registered on the system. There exists some information about legally approved data 28, and consent results for a given vehicle, the vehicle data 28 may also be anonymized such that full VIN (Vehicle Identification Number) are not used. The data collection system 16 is able to handle scheduling requests and checks the consent for each sensor data 28 used on the system.

The scheduling system may include geographic triggers or other trigger points that multiple vehicles shall use to start the data collection, processing and machine learning analysis, on-board, from the beginning and ending of what may be called a data collection job, and data processing, conditioning, machine learning (ML) job. The data collection is a set of data available from one or more sensors on the vehicles, FIG. 1 shows data from one or more sensors that may be collected on each motor vehicle 10. The sensors shown are not exhaustive, there are a plurality of sensors, not all sensors are shown in the figures.

The operator/engineer 20 schedules the duration of the data collection job and a data set or sets of sensor data 28 that shall be collected. This is based on a grouping of vehicles for processing on-board the vehicles and off-board on the cloud. The vehicle groups can be based on features of the motor vehicle 10 such as vehicle make and model, color of the motor vehicle 10 and also can be based on geographical regions. There can be triggers that are defined to only collect data 28 when a certain condition is met, for example if the speed data is less than 60 km/h.

Next, the operator schedules data processing, conditioning and machine learning analysis jobs, for example, which takes a data collection job as an input, Job A, for example, the operator schedules the collection of the vehicle sensor data 28, such as the Dash Cam Video, the vehicle telemetry like heading, speed, and then attaches a data processing and machine learning analysis job that operates on the collected data 28. The data processing, conditioning and machine learning analysis job has its own start and stop date/time and its own triggers and configurations. For example, a transformation task is defined, which processes raw speed sensor data 28 and then defines a conditioning job, which takes and normalizes the transformed speed value and the wheel rpm values. The data processing and machine learning analysis jobs are sent to the plurality of motor vehicles 24 in a group for on-board execution. The same data 28 may also be processed off-board on the cloud using the same scheduled data 28. There is a mechanism that allows jobs to be specified for only on-board, both on-board and off-board server side processing or only cloud server side processing.

An embodiment of the collection system 16 is shown in FIG. 2. The multi-vehicle traffic and scheduling system has a data registry of all vehicle and sensor data 28 available and features of each motor vehicle 10. The engineer 20 schedules these events using the multi-vehicle traffic and scheduling system, step S2.1. Once the data collection job and the data processing and machine learning analysis job have been created a start date/time and end date/time are established, the target groups of motor vehicles 10 have been established, then the jobs are sent to the “Vehicle Data Collection Scheduler Distribution System”, step S2.2. and the “Vehicle Data Processor and Machine Analysis Scheduler Distribution System”, step S2.3.

Once the data collection jobs and data processing and machine learning jobs are scheduled, they are sent from the cloud server services/micro-services to the motor vehicles 10 in a group, step S2.4 and S2.5.

The “On-Board Data Collector Manager & Scheduling” runs on the motor vehicles 10, it accepts scheduling and trigger data 28 that specifies which sensor data 28 shall be collected and what triggers shall be used during collection. The data collection jobs are sent to a “Vehicle Data Collections/Automation” module S2.8, the data collection automation communicates with a central data router S2.7 and the vehicle data emitters S2.6 in order to route raw sensor data 28 and vehicle data 28 to the “Vehicle Data Collections/Automation”. For example, a job may be defined as “There are more blue bikes than red bikes in San Francisco”. This job starts to route camera data 28 from the “dash cam sensor” and “rearview camera” to the data pipeline. The speed sensor is set up and the trigger is set to only capture data 28 where the speed is less than 60 km/h.

The “On-Board Data Processing, Conditioning and Machine Learning Scheduler” communicates S2.5 with the “Vehicles Data Processing Jobs Transformation, Conditioning Automation System” S2.9 and the machine learning data analysis jobs S2.10 are set up. The automation system starts processing incoming data 28 from the “Data Collector” S2.8 and a transformation is applied to the speed data 28 in order to convert from raw data 28 to km/h, if the speed is less than 60 km/h the “dash cam” and “rearview cam” data 28 are processed in the pipeline. The machine learning engineers 20 have specified the conditioning needed for the camera data 28, for example to run an image filter on each camera frame, then put in an array format before it is passed along to the machine learning model. The data processing conditioning algorithm S2.9 is applied and then puts in an array format and passes to the machine learning model for processing S2.10. The machine learning model, in this case it is an R-CNN neural network model, is run on the images from the vehicle, “Vehicle Data Analysis and Results” module S2.11, which identifies all the objects on the image along with the coordinates of the objects on the image. In addition, the colors of the objects are given as results from the machine learning model or models, as there may be more than one.

An “On-Board” “Vehicle Results Collector Distribution” module S2.12 packages all data results, which are to be reported back to the “Cloud Server Multi-Vehicle Data Big Data Acquisition and Ingest” S2.13. The on-board vehicle results collector sends “dash cam” and “rearview cam” data streams to the cloud-based ingest server, depending on the “Jobs” scheduler. The conditioned image data may be taken and may be sent back to the cloud-based server, in this case the images are ready for the cloud-based server to run its own machine learning models on the vehicle data 28. Only transformation data 28 for GPS 22, speed and heading, are sent.

The “Off-Board”, “Multi-Vehicle Data Big Data Acquisition and Ingest” S2.13 sends all the data to the “Multi-Vehicle Big Data Storage Data Lake” S2.14. If it is scheduled “Off-Board”, data processing or machine learning is performed during the “Multi-Vehicle Data Cloud Side Machine Learning Analysis” S2.15.

The scheduling system includes data collection, processing, machine learning reconciliation, this matches what is scheduled the multi-vehicles to collect and what data 28 and results were actually received, “Data Collection, ML Analysis Jobs Reconciliation” S2.16.

Finally, at the point “Data Scientists Jobs and Research Project Results GUI”, S2.17, the results from the data collection and machine learning models can finally be found. The Data Scientists may take the image recognition models results from all the motor vehicles 10 that participated in the campaign and those results can be compiled and it can be seen, for each day, for each motor vehicle 10 within the San Francisco boundary that the Dash Cam, for example, captured three bicycles, the color of the majority of the bicycles was blue, and it can be measured which of the bicycles were red. The data 28 from the rear view camera and dash camera can be compiled. Then the results may be analyzed using statistical methods and it is determined which is more common, red bicycles or blue bicycles.

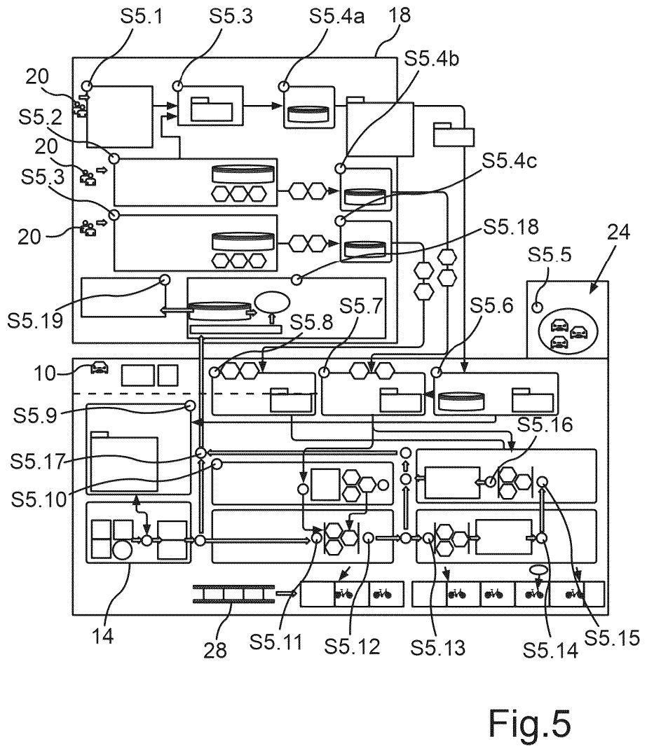

In order to be more precise in how data processing applications are used, machine learning (ML) models, such as neural networks, and the cloud-based vehicle data ingest and big data storage systems, some use cases may be presented. For example, the system schedules the collection of the dash cam video stream from a group of motor vehicles 24, from this data collection of the video stream a data pipeline can be established that dynamically downloads, installs and runs a “Data Processing Application A” that accepts 2D/3D dash cam video streams as input and outputs segmented sequenced video frame images that are suitable to be the input of a “Machine Learning Model A”, a neural network model, Mask-RCNN, see FIG. 5, steps S5.11, S5.12, S5.13, S5.14.

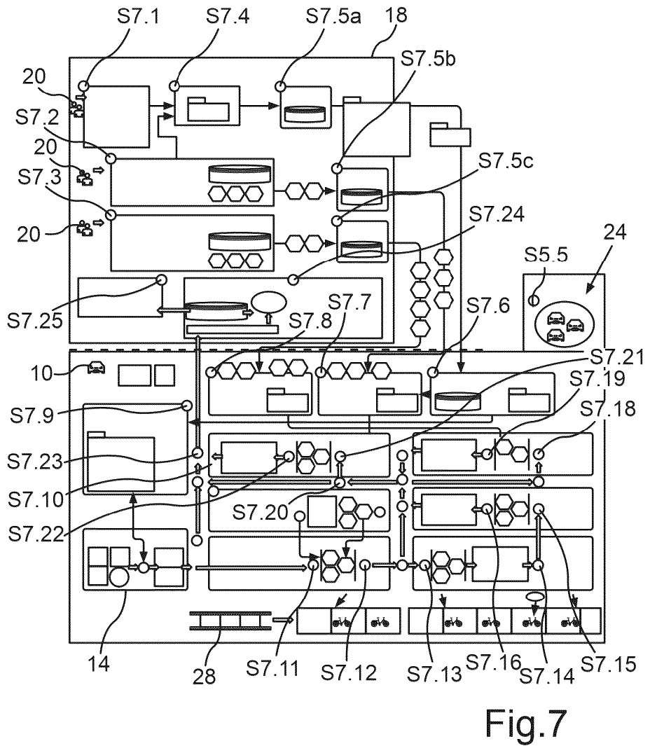

The collection system 16 may then send the results from the output of the “Machine Learning Model A” to the input of the “Data Processing Application B” which identifies and tracks bicycles within the frames captured by the dash cam. The output from “Data Processing Application B” is routed to the input of “Machine Learning Model B”, which is shown in FIG. 7, steps S7.15, S7.16, S7.17, S7.18, S7.19. Finally, the results at any “Data Flow Output” may be scheduled to be sent to the cloud-based servers for big data storage.

In order to demonstrate the solution this collection system 16 provides, a use case is now described as an example only.

First, a theory has to be established. For example, “What is the most common color of bicycles in San Francisco?” This question is posed to the engineer 20 who puts the question into the form of a hypothesis. The hypothesis is “Blue bicycles are more common than Red Bicycles in San Francisco”. From this hypothesis the data scientists can collect research data 28 from motor vehicles 10 in San Francisco using their dash cams, by sampling images of bicycles over the course of several weeks.

Second, there is no need to hire thousands of people to review dash cam video footage from many cars from many hours of dash cam video. The solution is to work with a machine learning and data engineers 20 in order to develop artificial intelligent (AI) analysis of the dash cam video footage. This is not a trivial process and shall require the machine learning engineers 20 to develop machine learning “Models” in order to identify bicycles in the dash cam video footage. The data engineers 20 need to collate all the dash cam videos and for that they need to develop data processing “Applications” to filter and collate all the dash cam videos and they enlist a “Software Engineer” to work with them to develop these “Data Processing Applications”.

Third, these “Models” and “Data Applications” are built off-board on the cloud server clusters using native dash cam video footage from all the motor vehicles 24, which may not be very efficient. To make this process more efficient, the model is built in stages, running some “Models” and “Data Applications” on-board the motor vehicles 10 and others on the cloud server clusters.

Finally, the collection system 16 dynamically allows scheduling when and what data is collected on groups of vehicles in the field, in this case when they are in San Francisco. We need a dynamic “Model Store” and “Data Application Store” that can distribute these Machine Learning “Models” and “Data Processing Applications” to groups of vehicles based on scheduling and configurations dynamically.

This process can be broken into three parts. In FIG. 3 it is presented how to develop the first part of the end-to-end data science question “Blue bicycles are more common than red bicycles in San Francisco”. In order to develop a first machine learning Model A, some dash cam video footage has to be collected.

FIG. 3 shows how to collect sample training data, schedule a data collection job A which schedules a group of motor vehicles 10 to start collecting dash cam video data 28 starting on Monday, and collect that data for one week. The system natively knows how to collect video streams from the dash cams and transmit them back to the cloud server, big data server.

There is a lot of data 28 with full video streams. Therefore, a data processing application A is added into the data stream pipeline S3.13. In order to apply this data processing application A to the pipeline, a request is pushed to a group of motor vehicles 24 to download a new data application A dynamically, and apply the app A to the pipeline. This is done with the “Vehicle Data Scheduler” S3.1. The software and data engineers 20 develop an application that reads the dash cam video as input and picks out a subset of images and puts them into a collection with minimum resolution, wherein there is a need to input machine learning model A which is still being built, which is presented by S3.2 The vehicle data schedules and packaging S3.3 creates instructions for the group of motor vehicles 24 in the field to download the “Data Processing Application A” from the “Data Application Store”. During S3.4 and S3.5 the “Application A” is published on an App Store for motor vehicles 10 to download. The actions are scheduled to begin on Monday and end on Friday, which instructs the motor vehicle 10 to apply the pipeline shown in steps S3.10-S3.14.

The motor vehicle 10 receives the scheduling package S3.6. The vehicle scheduler reviews this package and schedules the dash cam to start recording on Monday, and send the video stream data 28 to the application A for processing and further sends it to the vehicle data automation system S3.8. At the same time the motor vehicle 10 downloads the application A from the “Application Store”, installs it and connects its pipeline, which is shown in S3.7 and S3.10. At the same time, if there are any libraries that should be applied “Just In Time” (JIT), it then compiles and links those libraries and also installs those libraries in S3.9 and S3.10.

Once the data applications are installed and running, the data collection process can be started, video streams can be read from the dash cam, the video using data processing application can be processed, which is represented by S3.10, S3.11 and S3.12, and finally the “Application A” processed images are uploaded, which are image segments rather than the full video stream. For example, the full video stream may be uploaded using step S3.13 directly from the dash cam, which is full video. The “Processed” dash cam video may be split into continuous segments of video, one every 5 frames, and each frame may be scaled and further compressed using the data processing application. This second, processed data is more efficient and useful than the full video streams.

This process of running Job A on a group of motor vehicles 10 is performed during the first week in San Francisco and provides the “Training Data” needed to move to the next stage in the model development.

FIG. 4 shows another part of the process. During this part of the use case a new machine learning model, “Model A”, is created, which is a neural network model, for example a “mask-RCNN” type of model that identifies a bicycle in each frame of dash cam video. It identifies which frame and what time, it captures the bicycle and creates a mask of the bicycle image, it draws an outline of the bicycle, and it gives the coordinates of the bicycle within the frame of video.

The saved data from Job A is used running on all the motor vehicles 10, all the motor vehicles 10 that have reported their results, both raw dash cam video and processed image segment sequences from the output of our “Data Processing Application A”. The machine learning engineer 20, data engineer 20 and software engineer 20 all work together to make the pipeline most efficient and accurate. A pipeline is now presented, from the dash cam collector, to the data processing application A, as shown in S4.3 and S4.4, into input of machine learning model A, S4.4, S4.5, S4.6 and S4.7. The output is a sequence of images that identify bicycles in each frame or sample frames. It can be identified what are the coordinates of the bicycle and how many bicycles were captured in the frame. There might be one whole bicycle, a front of another bicycle, and another bicycle further away in the corner of the image. All this data 28 now needs some additional stages to allow for fully reaching conclusions.

According to FIG. 5 a new Job B might be created for all the motor vehicles 10 in San Francisco in the group. It is started by creating the Job B, in the scheduler, S5.1. Next, the upgraded “Data Application A version 2”, “Data Application B” and machine learning “Model A” are placed within the system and scheduled and a package with all the scheduling and configuration data 28 is created S5.3. The data processing applications are placed on the “Data Application Store” and the machine learning models are placed on the “Model Store”, S5.4.

The new Job B is pushed to all the motor vehicles 10 in the group in this case San Francisco S5.5. The motor vehicles 10 receive this new package for Job B and the package actions are parsed and the data sensor collection actions, data processing and machine learning schedules are sent to the automation system S5.9. The updated “Data Processing Application A v2” and new application “App 2” are downloaded from the cloud server's “App Store” and then installed onto the on-board motor vehicle 10. The new “Machine Learning Model A” is downloaded from the cloud server “Model Store” and this is installed on-board the vehicle system and the pipeline is configured S5.6, S5.7 and S5.8.

At the correct time of day the automation system starts collecting the dash cam streams and runs them to input S5.11, where the updated “Application A v2” processes the dash cam video GOPs into segmented sequenced images, where the images are filtered and prepared for input into the machine learning Model A S5.12 and S5.13. The machine learning model A then applies the Mask-RCNN machine learning model on the images and produces a result with the number of bicycles found, their dimensions, and coordinates are reported for each image in the frame S5.13 and S5.14

Next, the output results from the machine learning model A are passed to the input of the “Data Processing Application B” S5.14 and S5.15. From this point the new data processing identifies in which frame it first captures a bicycle, tracks its position, and identifies in which frame the bicycle can no longer been seen S5.15 and S5.16.

Finally, at S5.17 the resulting data 28 can be sent to the cloud server big data storage system. There are less data 28 sent since the full dash cam video stream is not transmitted, and the data 28 is much more specific to the questions than before. There is the pipeline to send data 28 from the output of the dash cam, or output of the first data processing application. As the pipeline is developed a new configuration is sent to the motor vehicles 10 in the group to start or stop collecting data 28 at different points in the pipeline. The next step is to work on the final stages, machine learning model B and data processing application C.

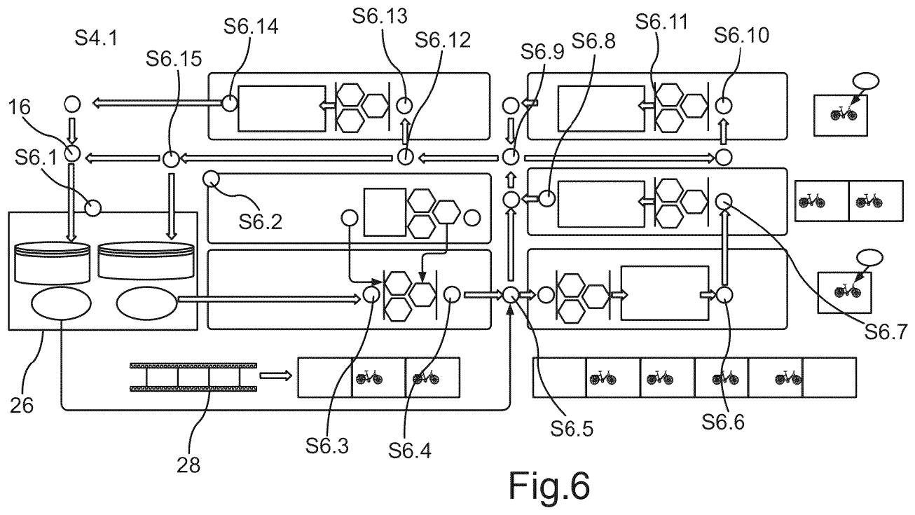

In FIG. 6, once the models have been “pre-trained”, they can be easily distributed and applied to the motor vehicles 10 using the collection system 16. In this phase dash cam video data stored on the big data servers is replied. There are now both native streams from Job A and segmented, sequenced data 28 with bicycle identifications data 28 available. In the final model identifying for each unique detected bicycle what is the most significant color and the colors percentage compared to other colors is performed. This provides the collection system 16 with the final data 28 that the data scientist can use to complete their research reports.

Finally, the end-to-end model is developed and the final Job C is distributed to all the motor vehicles 10 in the group of motor vehicles 24, which is shown in FIG. 7. In this case the data collection events, the data processing and machine learning pipeline are scheduled S7.1. The machine learning, data engineers and software engineers are involved in submitting final versions of the machine learning models A and B, and data processing applications A, B, C and a package to inform all the motor vehicles 10 in the group is created to start downloading the models from the “Model Store” and data processing applications from “Data App Store”, S.7.2, S7.3 and S7.4. The vehicle distribution system and “Model Store” and “Data App Store” actually transmit the package to all motor vehicles 10 in the group S7.5.

On-board the motor vehicle 10 it receives the package Job C and examines the scheduling data 28 and determines which sensors the collecting process starts collecting from and when to start collecting and sends these events to the automation system, step S7.9. During steps S7.7 and S7.8 the motor vehicle 10 downloads the “Machine Learning Models A & B” from the “Model Store” and downloads the “Data Processing Applications A, B & C” from the “Data App Store”. The data applications and models are then installed on the motor vehicle 10.

Any Just In Time (JIT) compilation and linking is performed in order to create an application based on configuration data 28. A data application is requested to be created on-board the motor vehicle 10 rather than being downloaded S7.9 and S7.10. In the presented case a data processing application Z is compiled, linked and installed in these steps. The purpose of the data application Z in this case is to process raw latitude, longitude, heading data. In this case it is more efficient to compile at run time rather than download the data app.

At a specified time of day the collection system 16 starts to collect dash cam video and to send it to the input of the data processing application A, which segments, sequences and filters the frames of images in the video stream S7.11 and S7.12. The output from this process is provided to machine learning model A S7.13 and S7.14. The machine learning model A identifies for each frame each bicycle within the frame, a mask of the bicycle and coordinates within the frame. This data is then output into the “Data Processing Application B” which takes the sequence of images, frames, and figures out when a bicycle enters the frame and exits the frame, it tracks how many unique bicycles over the sequence are evaluated S7.15 and S7.16.

The final two stages are shown at the input of the “Machine Learning Model B”. This machine learning model identifies, for each bicycle in each frame, what colors the bicycle is, 80% blue, 20% white, and percentage of confidence of these values. This is the last part of the artificial intelligence (AI) which is needed in this model S7.17, S7.18 and S7.19. The last stage is a “Data Processing Application C”. This application takes the output from the machine learning model B and determines how many bicycles are captured and the colors of each of the bicycles over the sequence segmented video frames and some value of overall confidence to record in the big data server S7.21 and S7.22.

Finally, the results of the data 28 are reported to the machine learning server in the cloud. In this case the entire dash cam video pipeline is completed entirely on the vehicle so that no actual images are not sent from the motor vehicle 10 to the cloud server S7.23 and S7.24. The final step is for the data engineer 20 and the data scientist to work together to measure the value of the data 28 collected if there are any changes required in the pipeline.

If there are any changes needed in the final end-to-end pipeline, the machine learning engineers 20 can make changes to the models A and B, perhaps re-training and sending updates, such that there is a “Machine Learning Model A v2” in this case the new version is posted on the “Model Store” and a new Job X is sent to those motor vehicles 10 that should apply the new model. In this way it is possible to dynamically send “Machine Learning Model” updates and also “Data Processing Application” updates to the “Model Store” and “Data App Store” for download at a later stage.

Now it is possible to finally answer the questions and finish the research, using the data models, data collection and data applications designed, developed, and distributed dynamically to groups of motor vehicles 10 in the field.

The question may be for example “What is the most common color of bicycles in San Francisco?”. Over the course of several weeks the model developed in the previous part is distributed to a group of motor vehicles for example in the Bay Area. Whenever the motor vehicle 10 enters San Francisco it begins running the Job which collects dash cam video, converts to segmented and sequenced frames, identifies bicycles, identifies unique bicycles and what colors were reported. It sends all this data to the big data cloud servers for data scientist to analyze.

The data scientist performs research using the data points, for example only,:
Start Date: Monday
End Date: Friday
Num Vehicles Reporting: 10,000
Results Example:
Monday 10am-11am
Num Bicycles Seen: 100
Average of Colors:
Blue: 60%
Red: 30%
White: 10%
“Blue bicycles are more common than Red Bicycles in San Francisco”
Conclusion: “Yes, blue bicycles are more common than Red Bicycles in San Francisco”

This data 28 can then be used to produce more Blue Color bicycles in San Francisco which is the data 28 driven manufacturing proposal based on the research.

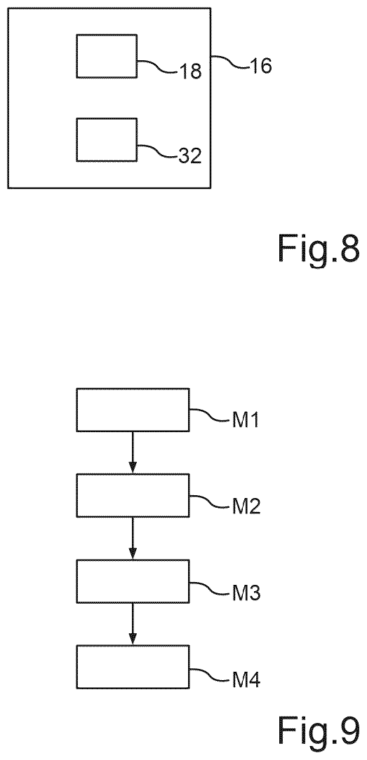

FIG. 8 shows a schematic block diagram of an embodiment of the data collection system 16 for collecting data 28 of their surroundings 30 from a plurality of motor vehicles 24, comprising at least one server 18 and at least one communication device 32.

FIG. 9 shows a schematic flow chart according to an embodiment of the method for collecting data 28 of a surrounding 30 of a plurality of motor vehicles 24 by a data collection system 16. In a further first step M1 generating, by the data collection system (16), a collection job comprising a first set of information, which describes which data are to be collected by the plurality of motor vehicles 24, and a second set of information, which describes when the data are to be collected, for the plurality of motor vehicles 24 is performed. In a further second step M2 transmitting, by the data collection system 16, the collection job to the plurality of motor vehicles 24 by a communication device 32 of the data collection system 16 is performed. From each motor vehicle 10, preprocessed data 28 are received, wherein the surroundings 30 of each motor vehicle 10 were captured by a capturing device 12a to 12g of each motor vehicle 10 depending on the transmitted collection job to generate collected data 28 and the collected data 28 were preprocessed by an electronic computing device 14 of each motor vehicle 10 to generate preprocessed data, which is shown in a further third step M3. In a further fourth step M4 further processing of the transmitted and preprocessed data 28 by the backend server 18 is performed.

### REFERENCE SIGNS

10 motor vehicle
12a-12g capturing device
14 electronic computing device
16 data collection system
18 backend server
20 engineer
22 GPS
24 plurality of motor vehicles
26 big data storage
28 data
30 surroundings
32 communication device
S1.1-S7.25 steps of the method
M1-M4 steps of the method

Claims

1

-

7

. (canceled)

8. A method for data collection system to collect data of a surrounding of a plurality of motor vehicles, the method comprising:
generating, by the data collection system, a collection job comprising a first set of information describing which data are to be collected by the plurality of motor vehicles, and a second set of information describing when the data are to be collected by the plurality of motor vehicles;
transmitting, by the data collection system using a communication device of the data collection system, the collection job to the plurality of motor vehicles;
receiving, by the data collection system from each of the plurality of motor vehicles, preprocessed data, wherein the surroundings of each of the plurality of motor vehicles were captured by a capturing device of each of the plurality of motor vehicles depending on the transmitted collection job to generate collected data, wherein the collected data were preprocessed by an electronic computing device of each motor vehicle to generate preprocessed data; and
further processing of the transmitted and preprocessed data by a backend server of the data collection system.

9. The method of claim 8, wherein the preprocessing on each of the plurality of motor vehicles is performed by a machine learning algorithm of each electronic computing device of the plurality of motor vehicles.

10. The method of claim 9, wherein the method for preprocessing on each of the plurality of motor vehicles is specified in the collection job.

11. The method of claim 8, wherein the capturing device by which the surroundings are to be captured is specified in the collection job.

12. The method of claim 8, wherein collection of the data is triggered by a predetermined event in the surroundings, wherein the predetermined event is specified in the collection job.

13. The method of claim 12, wherein a trigger for the collection of the data is a current position of a motor vehicle of the plurality of motor vehicles, a current speed of the motor vehicle of the plurality of motor vehicles, a current heading of the motor vehicle of the plurality of motor vehicles, or a current time.

14. A data collection system to collect data of a surrounding of a plurality of motor vehicles, the data collection system comprising:
at least one server; and
at least one communication device coupled to the at least one server, wherein the data collection system is configured to
generate a collection job comprising a first set of information describing which data are to be collected by the plurality of motor vehicles, and a second set of information describing when the data are to be collected by the plurality of motor vehicles;
transmit, using the at least one communication device, the collection job to the plurality of motor vehicles;
receiving, from each of the plurality of motor vehicles, preprocessed data, wherein the surroundings of each of the plurality of motor vehicles were captured by a capturing device of each of the plurality of motor vehicles depending on the transmitted collection job to generate collected data, wherein the collected data were preprocessed by an electronic computing device of each motor vehicle to generate preprocessed data; and
further process the transmitted and preprocessed data.
